(19) United States
(12) Patent Application Publication
(10) Pub. No.: US 2008/0025412 A1
(43) Pub. Date: Jan. 31, 2008

(54) METHOD AND APPARATUS FOR PROCESSING VIDEO STREAM

(75) Inventors: Kun-Bin Lee, Taipei City (TW); Chi-Cheng Ju, Hsinchu City (TW); Yung-Chang Chang, Taipei City (TW); Chih-Ming Wang, Taipei County (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: MEDIATEK INC., Hsin-Chu (TW)

(21) Appl. No.: 11/829,167

(22) Filed: Jul. 27, 2007

Related U.S. Application Data
(60) Provisional application No. 60/820,609, filed on Jul. 28, 2006.

(51) Int. Cl. H04N 11/02

(52) U.S. Cl. 375/240.25; 375/E07.19

(57) ABSTRACT

For processing, e.g. encoding or decoding, a video stream, a type of a current macroblock unit is determined. The type indicates portions of corresponding macroblock parameter sets necessary for processing the current macroblock unit. The corresponding macroblock parameters are mapping to a dependent set of macroblock units of the current macroblock unit. The current macroblock unit is processed if a local buffer already stores the portions of the corresponding macroblock parameter sets. If data of the portions of the corresponding macroblock parameter sets that are not available in the local buffer, the data are copied from a memory circuit into the local buffer for processing the macroblock unit.

### CROSS REFERENCE TO RELATED APPLICATIONS

This application claims the benefit of U.S. Provisional Application No. 60/820,609, filed on Jul. 28, 2006, which is incorporated herein by reference.

### BACKGROUND OF THE INVENTION

1. Field of the Invention

The invention relates to a method and apparatus for processing a video stream and more particularly relates to a method and apparatus for processing a video stream that is coded based on macroblock units.

2. Description of the Related Art

Video processing, including decoding and encoding, keeps developing rapidly. Such development brings higher compression ratio so as video can be stored and broadcasted more and more efficiently. Most current video coding methods or standards, e.g. H.264, MPEG2, AVC, etc., are encoded and decoded based on macroblocks. That is, a frame is divided into a plurality of macroblocks. Spatial and temporal relationships among macroblocks are analyzed and utilized during coding for increasing higher compression ratio. Under certain coding design, two or more than two macroblocks may be grouped together as a basic unit for performing operations. In the following description, the term of “macroblock unit” or “MBU” refers to a basic operating unit that may contain one or more than one macroblocks.

Please refer to FIG. 1. FIG. 1 is a diagram illustrating a portion of a video frame 100 comprising a plurality of macroblocks, taking H.264 as an example. In FIG. 1 the macroblock units are 16×16 pixels for non-MBAFF (macroblock-based adaptive frame/field) coding and are 16×32 pixels or 16×16 pixels for MBAFF coding, but these are merely examples. If macroblock unit MBU5 is a current macroblock unit to be encoded or decoded, then information from MBU0, MBU1, MBU2, and MBU4 may be used. If macroblock unit MBU6 is the current macroblock unit to be encoded or decoded, then information from MBU1, MBU2, MBU3, and MBU5 may be used. In other words, a current macroblock unit may require information from a top left macroblock unit, a top macroblock unit, a top right macroblock unit, and an adjacent macroblock unit.

Encoding and decoding based on macroblocks are more and more complicated. Every factor during implementation, therefore, needs to be well considered so as to construct a practical product to be conveniently used and accepted by end users.

### BRIEF SUMMARY OF THE INVENTION

A preferred embodiment is a method for processing a video stream based on macroblock units. Each macroblock unit is corresponding to at least one macroblock of a frame in a video stream. The method includes the following steps.

A dependent set of macroblocks for a current macoblock unit is identified. The dependent set of macroblock units may include “neighboring macroblocks”, which is a term used in H.264. In other words, the dependent set of macroblock unit of a current macroblock unit includes macroblock units which macroblock parameter sets may be necessary for processing the current macroblock unit. An example of the dependent set of macroblock units of a current macroblock unit may include an upper-left macroblock unit, an upper macroblock unit, an upper-right macroblock unit and a left macroblock unit of the current macroblock unit. But, it is to be noted that components of the dependent set may be changed under different coding schemes or different locations of the current macroblock unit. For example, when a frame is coded into several slices, an upper-left macroblock unit may no longer be in the dependent set of one current macroblock unit.

When the necessary portions of macroblock parameter sets of the dependent set of the current macroblock unit are already stored in a local buffer, the current macroblock unit can be processed. The term “necessary portion” may be referred to parameters used for certain coding tools. If some part of the necessary portions of the macroblock parameter sets of the dependent set are not already stored in the local buffer, the missed parts are copied from a memory circuit to the local buffer. In addition, a type of the current macroblock unit is determined so that it can be decided which portions of macroblock parameter sets are necessary for processing the current macroblock unit. In addition, the following four exemplary approaches may further enhance processing a video stream.

In the first exemplary approach, unnecessary portions of the macroblock parameter sets are also copied to the local buffer because the unnecessary portions of the macroblock parameter sets may be necessary for processing a next macroblock unit. In the second exemplary approach, each macroblock parameter set includes a first group parameters and a second group parameters. The first group parameters are for a lower-left macroblock unit and the second group of parameters are for a lower macroblock unit. To process the current macroblock unit, the second group parameters of an upper macroblock unit and the first group parameters of an upper-right macroblock unit are copied from the memory circuit to the local buffer. In the third approach, at least a portion of the local buffer is shared for storing parameters of at least two mutually exclusive coding protocols, e.g. inter prediction parameters and intra prediction parameters. In the fourth approach, inter prediction parameters are loaded to the local buffer because the inter prediction parameters are very frequent to be used in interceded slice.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 illustrates relationship among macroblock units;

FIG. 2 is a diagram illustrating a preferred embodiment of an electronic apparatus that process a video stream;

FIG. 3 illustrates an image frame composed of macroblocks;

FIG. 4 illustrates a macroblock unit composed of two vertically adjacent macroblocks;

FIG. 5 illustrates a current macroblock unit and its dependent set of macroblock units;

FIG. 6 illustrates a current macroblock unit and its dependent set of macroblock units;

FIG. 7 illustrates a pipeline processing for macroblock units;

FIG. 8 illustrates relationship among macroblock units;

FIG. 9 illustrates storage contents of a local buffer;

FIG. 10 illustrates a sequence for loading parameters into a local buffer;

FIG. 11 illustrates contents stored in a memory circuit; and

FIG. 12 illustrates a flowchart of the preferred embodiment.

### DETAILED DESCRIPTION OF THE INVENTION

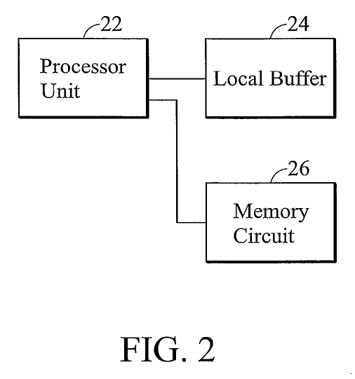

FIG. 2 is a diagram illustrating such an electronic apparatus of a preferred embodiment that includes a processor unit 22, a local buffer 24 and a memory circuit 26. The processor unit 22 may be referred to any customized circuits, instructions and hardware circuit for running the instructions or any combinations thereof. In real design, the processor unit 22 may be an integrated chip, a portion of an integrated chip or any combinations of software/hardware. The processor unit 22 may directly access both the local buffer 24 and the memory circuit 26. Alternatively, the processor unit 22 may need to access the memory circuit 26 via an additional memory controller (not illustrated). The processor unit 22 may move data between the local buffer 24 and the memory circuit 26 directly. Or, the processor unit 22 may request an additional circuit to move data between the local buffer 24 and the memory circuit 26.

The electronic apparatus is designed for processing, e.g. encoding and/or decoding, a video stream. In encoding, the video stream may be referred to a series of image frames that are converted into a bit stream. In decoding, the video stream may be referred to a bit stream that is parsed and decoded to reproduce a series of image frames. Both in decoding and encoding, a macroblock unit is a basic unit for performing operation thereon.

Most of current popular video coding adopt macroblock base coding, e.g. H.264, MPEG 2, MPEG 4, MPEG 7, AVC, etc. When an image is coded in macroblock base, more similarities usually can be found among macroblocks in a same frame or in different frames. Such similarities can be utilized for increasing high compression ratio.

This invention to be explained below may be applied for any coding schemes that are based on macroblocks. For common implementation details for each coding schemes, persons skilled in the art may find lots of reference materials. With the following description, persons skilled in the art should know how to combine their common implementation and the features of the present invention. For example, H.264 is a coding scheme based on macroblocks. Persons skilled in the art may get an overall understanding for how to utilize macroblocks to achieve high compression ratio from many articles like, “Overview of the H.264/AVC Video Coding Standard,” in IEEE Transactions on Circuits and Systems for Video Technology, Vol. 13, No. 7, July 2003. In this article, Intra-Frame Prediction, Inter-Frame Prediction and other techniques like Slice Group are explained very clearly. Since such context knowledge is already known by persons skilled in the art, such context knowledge, except those related to integrate the invention, is not repeated here again.

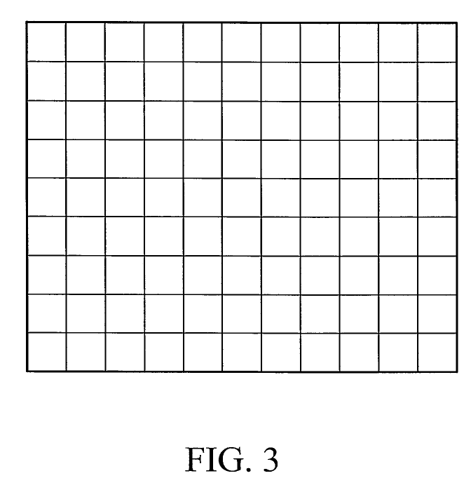

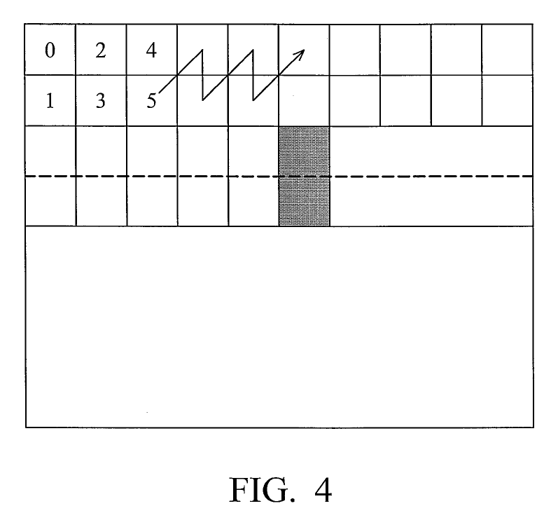

FIG. 3 illustrates an example of a QCIF picture that contains 11 by 9 macroblocks. A macroblock unit may include one single macroblock, two macroblocks or more than two macroblocks under certain coding patterns or coding tools. In the example illustrated in FIG. 4, a macroblock unit includes two vertically adjacent macroblocks. For example, the macroblock unit 0 and macroblock unit 1 are grouped as a basic unit for performing operation.

When encoding or decoding a current macroblock unit, information of neighboring macroblock units is necessary for processing the current macroblock unit. Such information of neighboring macroblock units is called “macroblock parameter set” here. A macroblock parameter set is corresponding to a macroblock unit and may include, but not limited to, some of information like Luma Intra Mode, Chroma Intra mode, Reconstructed pixel, Motion Vectors, Reference indices, Direct mode flag, Slice ID, Field decoding flag, MB type, etc., taking H.264 as an example. Not every parameter in a macroblock parameter set of one macroblock unit is necessary for processing a related macroblock unit. For example, the parameters of “Luma Intra Mode”, “Chroma Intra Mode” and “Reconstruction pixels” in neighboring macroblock units, which are related to intra prediction, may not be necessary for coding a macroblock unit with a coding type indicating that the macroblock unit should be processed under an inter prediction mode.

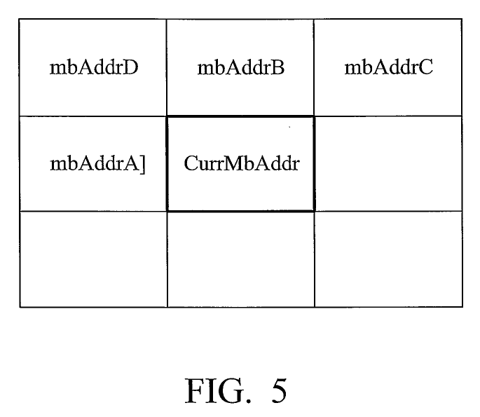

In FIG. 5, a macroblock unit contains one macroblock. When the macroblock unit at CurrMbAddr is to be processed, portions of macroblock parameter sets of the macroblock units at mbAddrA, mbAddrB, mbAddrC and mbAddrD are necessary.

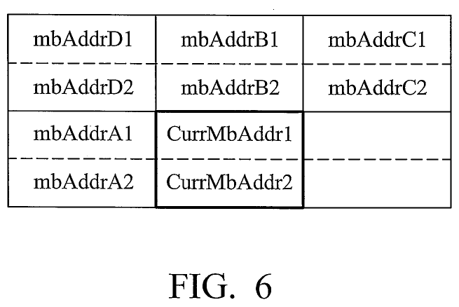

In FIG. 6, a macroblock unit contains two adjacent macroblocks. When the two macroblocks at CurrMbAddr1 and CurrMbAddr2 are grouped as a macroblock unit to be processed, the macroblock parameter sets of the macroblocks at mbAddrA1, mbAddrA2, mbAddrB1, mbAddrB2, mbAddrC1, mbAddrC2, mbAddrD1 and mbAddrD2 may be necessary. It is also possible that the macroblocks at CurrMbAddr1 and at CurrMbAddr2 are called a macroblock pair, but these two macroblocks are regarded as two macroblock units. In such case, the macroblock at mbAddr2 may use information at CurrMbAddr1, mbAddrA, mbAddrB1, mbAddrB2, etc. Moreover, the macroblocks at CurrMbAddr 1 and CurrMbAddr2 may be classified into two types, e.g. one for inter prediction type and the other for intra prediction type.

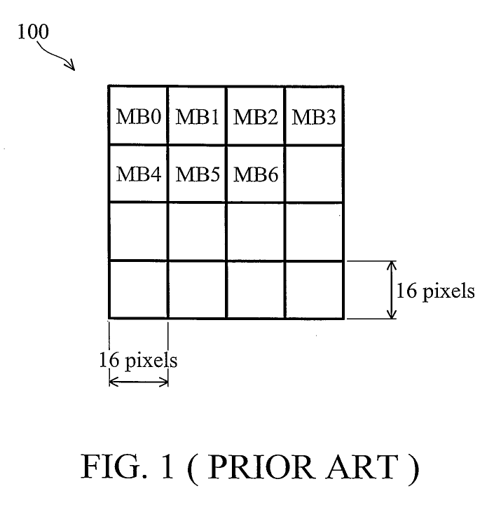

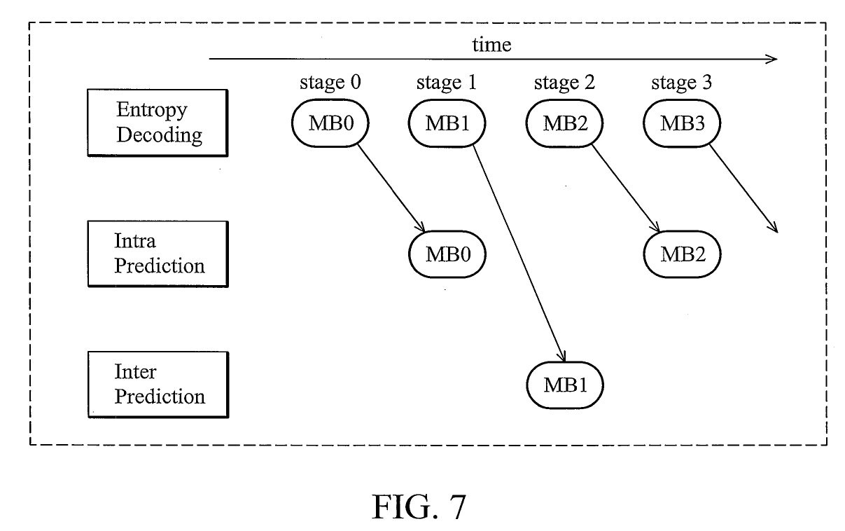

The processor unit 22 of the electronic apparatus in FIG. 1 may contain pipeline design. For example, FIG. 7 illustrates an exemplary pipeline design with two pipeline stages, i.e. entropy decoding and prediction (either intra prediction or inter prediction). In time stage 0, a macroblock unit, MB0, is decoded. After the entropy decoding, the type of MB0 indicates that MB0 is coded with Intra Prediction. In time stage 1, therefore, the MB0 is processed with intra prediction algorithms and corresponding portions of macroblock parameter sets of neighboring macroblock units are referenced to continue decoding the MB0. Besides, in this example, the coding type of the macroblock MB1 indicates that MB1 is coded under Inter Prediction. In time stage 2, therefore, the MB1 is processed with inter prediction algorithms and corresponding portions of macroblock parameter sets of neighboring macroblock units are referenced to continue decoding the MB1.

It is to be noted that neighboring macroblock units of a current macroblock (the macroblock that is currently processed) here are called “a dependent set of macroblock units” of the current macroblock. The dependent set of macroblock units may be changed depending on where a current macroblock locates. For example, the dependent set of macroblock units may include an upper-left macroblock unit, an upper macroblock unit, an upper-right macroblock unit and a left macroblock unit of a current macroblock unit. But, when the macroblock unit is at boundary of a frame, the dependent set may not include all macroblock units as mentioned in the previous example. Besides, when a frame is divided into a plurality of slices, a dependent set of macroblock units of a current macroblock unit may be composed of different neighboring macroblock units.

In other words, it is complicated to implement the electronic apparatus of FIG. 1, at least because there are many accesses for macroblock parameter sets for processing a macroblock unit. In prior art, necessary portions of macroblock parameter sets from an dependent set of macroblock units of a current macroblock unit are read each time from a memory circuit like a DRAM, a SRAM or a flash memory. It is noted and found in this invention that such traditional ways for retrieving macroblock parameter sets are inefficient. In the following descriptions, four exemplary data access approaches are disclosed for enhancing access to necessary macroblock parameter sets.

In general, the processor unit 22 in FIG. 1 determines a type of a current macroblock unit. The type may be used for indicating which portions of macroblock parameter sets of a dependent set of macroblocks of a current macroblock unit are necessary for processing the current macroblock unit. If the local buffer 24 in FIG. 1 already stores the necessary portions of the macroblock parameter sets, the processor 22 in FIG. 1 processes the current macroblock unit. If the necessary portions of the macroblock parameter sets are not available in the local buffer 24, the processor unit 22 copies necessary data from the memory circuit 26 into the local buffer 24.

In the first exemplary approach, the processor unit 22 further copies unnecessary portions of the macroblock parameter sets from the memory circuit 26 into the local buffer 24. The “unnecessary portions” of the macroblock parameter sets are not necessary for processing the current macroblock unit according to the type of current macroblock unit. The “unnecessary portions”, however, may be necessary for processing a next macroblock unit.

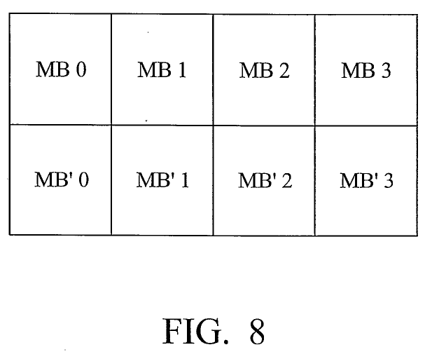

Taking FIG. 8 as an example, the processor 22 may find that the type of MB′0, which is the current macroblock unit, is intra prediction type. Therefore, “Motion vectors”, which is for inter prediction coding, in the macroblock parameter set of MB0 is not necessary for processing MB′0. The processor 22, nevertheless, still retrieves parameters like “Motion vectors” from the memory circuit 26 into the local buffer 24 because processing MB′1 may need the parameter of “Motion vectors” of MB0. Under the first approach, memory access is more regular. In addition, data arrangement for macroblock parameter sets is easier and more scalable. Pipelining among stages of decoding or encoding is also more flexible.

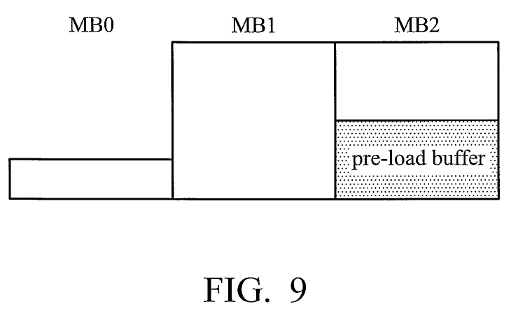

Besides, the space in the local buffer 24 may be released when the space contains portions of macroblock parameter sets that are no longer necessary for processing a next macroblock unit. For example, when MB′1 is the current macroblock unit to be processed and the type of MB′1 is determined, the space for storing portions of the macroblock parameter set of MB0 may be released for storing other data as illustrated in FIG. 9.

Moreover, if the current macroblock unit is the last one of a row, the macroblock parameter sets for processing the first macroblock unit in the next row are stored from the memory circuit to the local buffer.

On the way for processing macroblock units, corresponding macroblock parameter sets are obtained. These macroblock parameter sets are written to the memory circuit 26. Usually, the memory circuit 26 may contain macroblock parameter sets of a row of macroblock units.

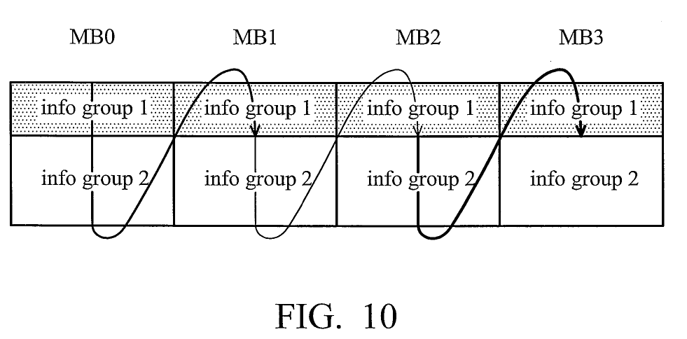

In a second exemplary approach, each macroblock parameter set may include a first group parameters and a second group parameters. The first group parameters, which may contain both inter prediction and intra prediction parameters, are for a lower-left macroblock unit and the second group of parameters, which may contain both inter prediction and intra prediction parameters, are for a lower macroblock unit. To process the current macroblock unit, the second group parameters of an upper macroblock unit and the first group parameters of an upper-right macroblock unit are copied from the memory circuit 26 to the local buffer 24. When such approach is adopted, data access follows the order as illustrated in FIG. 10. The “info group 1” is corresponding to the “first group parameters” and the “info group 2” is corresponding to the “second group parameters.”

In a third exemplary approach, the local buffer 24 has at least a portion for storing parameters corresponding to at least two mutually exclusive coding tools. For example, a macroblock unit can not belong to the types of “Intra Prediction” and “Inter Prediction” at the same time. Therefore, the type of a current macroblock unit is decoded first. Then, only necessary portions of the macroblock parameter sets are loaded from the memory circuit 26 into the local buffer 24.

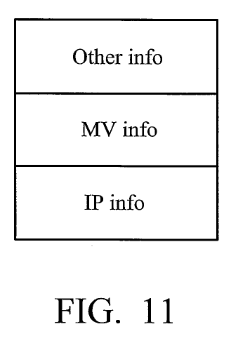

FIG. 11 is an exemplary diagram illustrates that all types of parameters that may be useful during processing are stored in different addresses the memory circuit 26. When these parameters are loaded to the local buffer 24, some parameters of mutually exclusive coding tools may share the same space of the local buffer 24. The “IP info” is for the type of “Intra Prediction” and the “MV info” is for the type of “Inter Prediction.” Besides, there are parameters of “Other Info” also being stored in the memory circuit 26. Under the third approach, only one of “MV info” and “IP info” is loaded to the local buffer 24. The local buffer 24 can be smaller.

In the fourth exemplary approach, inter prediction parameters are always loaded to the local buffer for inter-coded slices because the inter prediction parameters are frequently in an interceded slice.

In actual design, the hardware for implementing different types of processing may be shared. For example, a general processor executing associated instructions or programs may be used for performing both inter prediction and intra prediction. Of course, persons skilled in the art may design specific hardware circuits for implementing each type of processing to enhance processing speed. The memory circuit 26 or the local buffer 24 mentioned here may contain one or more than one storage devices like registers, DRAM, SRAM, flash memory, or any of their combinations.

Moreover, it is to be noted the approaches mentioned above may be implemented with several sets of hardware circuits running in parallel. For example, two sets of hardware circuits for inter prediction coding and intra prediction encoding are designed for running in parallel to determine which coding tool is better for the current macroblock. The several sets of hardware circuits may use the same local buffer. In other words, the same local buffer may contain data unnecessary for one set of hardware circuits but necessary for another set of hardware circuits.

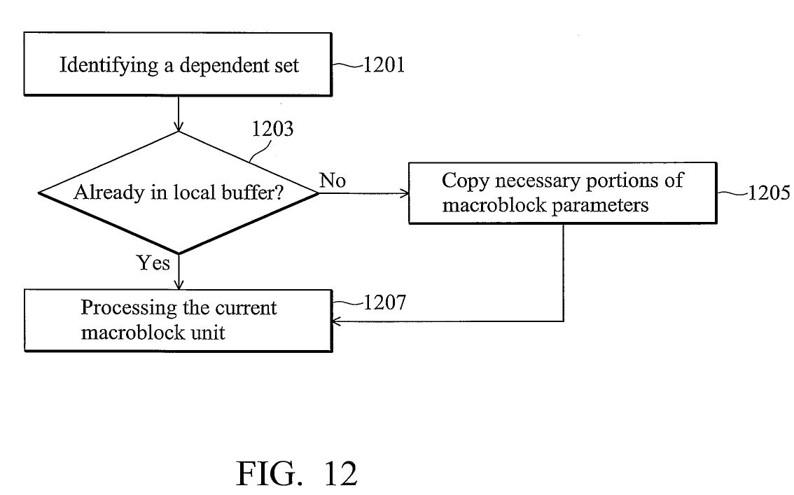

FIG. 12 is a flowchart illustrating a decoding method of the preferred embodiment. A dependent set of macroblock units for a current macroblock unit is determined (step 1201). Then, a check on whether necessary portions of the macroblock parameter sets of the dependent are already stored in a local buffer is performed (step 1203). If a local buffer does not store necessary portions of the macroblock parameter sets of the dependent set, these necessary portions are loaded to the local buffer from a memory circuit (step 1205). If the local buffer already stores necessary portions of the macroblock parameter sets of the dependent set, the current macroblock unit is processed (step 1207).

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for processing a video stream based on macroblock units, each macroblock unit corresponding to at least one macroblock of a frame in the video stream, the method comprising:
identifying a dependent set of macroblock units for a current macroblock unit;
processing the current macroblock unit if a local buffer already stores necessary portions of macroblock parameter sets of the dependent set of macroblock units; and
copying the necessary portions of the macroblock parameter sets of the dependent set of macroblocks that are not available in the local buffer from a memory circuit into the local buffer for processing the current macroblock unit.

2. The method of claim 1, further comprising:
determining a type of the current macroblock unit so that the type indicates which portions of the macroblock parameter sets are the necessary portions for the current macroblock unit.

3. The method of claim 1, wherein the dependent set of the macroblock units of the current macroblock unit comprises at least one of an upper-left macroblock unit, an upper macroblock unit and an upper-right macroblock unit of the current macroblock unit.

4. The method of claim 1, wherein the dependent set of macroblock units of the current macroblock unit further comprises a left macroblock unit of the current macroblock unit.

5. The method of claim 1, wherein one macroblock unit contains one macroblock.

6. The method of claim 1, wherein one macroblock unit contains at least two macroblocks.

7. The method of claim 1, further comprising:
copying unnecessary portions of the macroblock parameter sets of the dependent set of macroblocks that are not available in the local buffer from a memory circuit into the local buffer, wherein the unnecessary portions of the macroblock parameter sets of the dependent set of macroblocks are not necessary for processing the current macroblock unit, but are possible to be necessary for processing a next macroblock unit.

8. The method of claim 7, further comprising:
copying the necessary and the unnecessary portions of the macro block parameter sets corresponding to a first macroblock unit in a next row if the current macroblock unit is the last macroblock unit in a row.

9. The method of claim 1, further comprising:
releasing a space in the local buffer for storing the macroblock parameter sets that are no longer necessary for processing a next macroblock unit.

10. The method of claim 1, wherein the memory circuit stores macroblock parameter sets of at least one row of macroblock units.

11. The method of claim 1, wherein the processing comprises inter prediction and intradiction and both performed with a shared hardware circuit.

12. The method of claim 1, wherein each of the macroblock parameter set comprises a first group of parameters and a second group of parameters, the first group of parameters are for a lower-left macroblock unit and the second group of parameters are for a lower macroblock unit, and for processing the current macroblock unit, the second group of parameters from an upper macroblock unit and the first group of parameters from an upper-right macroblock unit are copied from the memory circuit to the local buffer.

13. The method of claim 1, wherein at least a portion of the local buffer is shared by at least two mutually exclusive coding tools for storing their necessary portions of the macroblock parameter sets of the dependent set of the macroblocks.

14. The method of claim 13, wherein different portions of one macroblock parameter set corresponding to different coding tools are stored in different addresses in the memory circuit.

15. The method of claim 1, wherein one macroblock parameter set comprises an inter prediction parameter portion and an intra prediction parameter portion and the method further comprising:
copying the inter prediction parameter portions of the macroblock parameter sets of the dependent set of macroblocks to the local buffer if the current macroblock unit belongs to an interceded slice.

16. An electronic apparatus for processing a video stream, the video stream comprising a plurality of frames and each frame comprising a plurality of macroblock units, the electronic apparatus comprising:
a memory circuit;
a local buffer; and
a processor unit coupled to the memory circuit and the local buffer, wherein the processor unit identifies a dependent set of set of macroblock units for a current macroblock unit; the processor unit processes the current macroblock unit if a local buffer already stores necessary portions of macroblock parameter sets of the dependent set of macroblock units; and the processor unit copies the necessary portions of the macroblock parameter sets of the dependent set of macroblocks that are not available in the local buffer from a memory circuit into the local buffer for processing the current macroblock unit.

17. The electronic apparatus of claim 16, wherein the processor unit determines a type of the current macroblock unit so that the type indicates which portions of the macroblock parameter sets are the necessary portions for the current macroblock unit.

18. The electronic apparatus of claim 16, wherein the processor unit copies unnecessary portions of the macroblock parameter sets of the dependent set of macroblocks that are not available in the local buffer from a memory circuit into the local buffer, wherein the unnecessary portions of the macroblock parameter sets of the dependent set of macroblocks are not necessary for processing the current macroblock unit, but are possible to be necessary for processing a next macroblock unit.

19. The electronic apparatus of claim 16, wherein each macroblock parameter set comprises a first group of parameters and a second group of parameters, the first group of parameters are for a lower-left macroblock unit and the second group of parameters are for a lower macroblock unit, and for processing the current macroblock unit, the second group parameters from an upper macroblock unit and the first group parameters from an upper-right macroblock unit are copied from the memory circuit to the local buffer.

20. The electronic apparatus of claim 16, wherein at least a portion of the local buffer is shared by at least two mutually exclusive coding tools for storing their necessary portions of the macroblock parameter sets of the dependent set of the macroblocks.
